(19) United States
(12) Patent Application Publication
(10) Pub. No.: US 2012/0011763 A1
(43) Pub. Date: Jan. 19, 2012

(54) RELEASABLE FISHING SINKER ASSEMBLY

(76) Inventor: Chi Huynh, San Dimas, CA (US)

(21) Appl. No.: 12/837,188

(22) Filed: Jul. 15, 2010

(51) Int. Cl. A01K 95/00

(52) U.S. Cl. 43/44.97

(57) ABSTRACT

A fishing sinker assembly is provided including a weighted body and an elongated insert. The weighted body includes a throughbore defining a cavity extending between two openings. The elongated insert extends through the cavity and includes a proximal end, a distal end, and a middle portion. The proximal end includes a connecting means for connecting the fishing sinker to a fishing line. The distal end is larger than the size of at least one of the openings, wherein the distal end prevents the body from being slidably removed over the distal end. The middle potion includes a breakaway segment positioned within the cavity. The breakaway segment has a tensile strength less than that of the proximal end, distal end and fishing line attached to the proximal end such that added tension will cause the breakaway segment to selectively break prior to breaking of the proximal end, distal end or fishing line.

### FIELD OF THE INVENTION

The present invention relates generally to fishing sinkers, and more specifically to a releasable fishing sinker assembly.

### BACKGROUND OF THE INVENTION

Sinkers have long been used on fishing lines to provide enough weight to pull line off a reel or spool during the casting process and to carry a baited hook to a desired depth below the surface of the water. Often, when fishermen attempt to reel in their fishing line the sinker becomes snagged on rock or debris below the surface of the water. Many times the sinker cannot be freed from its entanglement and the line must be cut causing loss of the sinker and of the hook or artificial lure attached to the end of the line.

In light of this problem, several solutions have been presented in the prior art. One solution presented is to provide a sinker assembly including two interconnected members, wherein one or both members are capable of deforming to disengage when the sinker becomes snagged. For example, U.S. Pat. No. 3,744,177 to Cron, Jr. sets forth a fishing sinker attachment means with an annular, resilient collar capable of stretching under tension to release the sinker. U.S. Pat. No. 4,125,958 to Cote sets forth a coupling assembly adapted to connect a fishhook to the remainder of a fishing line, including a resilient member capable of disengaging from the remainder of the assembly under tension to release the fishhook. U.S. Pat. No. 4,138,795 to Welle sets forth a fishing sinker with a resilient means for connection to a fishing line capable of stretching under tension to release the sinker from the fishing line. U.S. Pat. No. 4,837,968 to Lin sets forth a self-detachable sinker assembly including a flexible, elongate buckle belt fixed peripherally around an oval-shaped sinker capable of unbuckling under tension to release the sinker. U.S. Pat. No. 4,926,580 to Lin sets forth a sinker coupler including a fork end having two semi-sphere members made thereon for connecting to a sinker when they are squeezed to form into a spherical configuration and inserted into an inner chamber of the sinker. U.S. Pat. No. 5,054,227 to Lin sets forth an assembly including a resilient bulb and a weighted plummet, wherein the bulb may be deformed and pulled through the plummet under tension to release the plummet. U.S. Pat. No. 5,088,228 to Waldie, Jr. sets forth an assembly including a sinker having an opening and a spindle having a main body adapted to extend through the sinker opening and an enlarged, deformable base capable of deforming under tension to release the main body. U.S. Pat. No. 5,150,540 to Bennet sets forth an assembly including a coupling member capable deforming to release a sinker under tension. U.S. Pat. No. 5,375,365 to Bronder sets forth a releasable sinker having a sinker body and a disengageable attachment member consisting of two springable legs capable of disengaging the sinker body under tension. The weighted segment is capable of disengaging from the rubber tubing upon the sinker becoming snagged on an obstruction. US 2004/0134119 to Glavinich et al. sets forth a sinker assembly including a weighted body and a springed fork member capable of deforming to release the weight body under tension. With each of these patents, it may be difficult to manufacture deformable members such that they will reliably disengage before the fishing line breaks to release a snagged sinker.

Another solution presented in the prior art is to provide a weighted member engaged to a connecting member by means of surface friction. The weighted member is released when the assembly is snagged and tension forces are large enough to overcome the surface friction. U.S. Pat. No. 4,819,364 to Lill sets forth a pull-apart fishing weight with a separable head made of an elastomer resin and a weight member made of lead. U.S. Pat. No. 5,461,821 to Carter, Jr. sets forth a sinker having a length of rubber tubing and a weighted segment insertably engaged therein. Like the first solution, it may be difficult to manufacture surfaces to provide a friction sufficient to reliably hold the weighted and connecting members together but low enough to allow for disengagement when the sinker is snagged.

Another solution presented in the prior art is to provide a complex release mechanism capable of releasing a sinker when the fishing line is under tension. U.S. Pat. No. 4,267,659 to Grasso sets forth a housing including a notch and a release mechanism, wherein a portion of the release mechanism is adapted for pivotal movement within the notch and is capable of releasing the sinker when a fish strikes. U.S. Pat. No. 6,314,673 to Matteoli sets forth a release assembly including a hollow housing member with a release slot and a pin member slidably engaged within the housing member, wherein upon a fish striking the fishhook the pin moves, opening the slot and releasing the sinker. The moving parts and mechanical complexity provided by these patents make them prone to malfunction and failure, as well as too expensive for practical use. Furthermore, the mechanisms provided by these patents were designed to release a sinker upon a fish striking the hook, not to release a sinker upon a snag. Indeed, the presence of such bulky mechanical release devices may increase the possibility of snagging and such devices not function when entangled with underwater obstructions.

Another solution presented in the prior art is to provide a sinker assembly with a weakened segment capable of breaking under tension. U.S. Pat. No. 4,077,151 to Johnson sets forth a sinker consisting of a filled plastic bag capable of breaking along a perforated portion under tension to release the contents of the bag. U.S. Pat. No. 6,779,294 to Ames sets forth a breakable link with a weakened portion capable of breaking under tension. However, these patents do not locate the weakened segment within a cavity of the weighted member to protect the weakened segment. Accordingly, the weakened portion of these patents are exposed to the surrounding environment and may break even when the sinker is not snagged, such as when it comes into direct contact with underwater objects.

### SUMMARY OF THE INVENTION

The present invention addresses the deficiencies inherent in current fishing sinkers by providing a releasable fishing sinker assembly. More specifically, the present invention provides a fishing sinker assembly including a weighted body and an elongated insert. The weighted body includes a throughbore defining a cavity extending between two openings. The elongated insert extends through the cavity and includes a proximal end, a distal end, and a middle portion. The proximal end includes a connecting means for connecting the fishing sinker to a fishing line. The distal end is larger than the size of at least one of the openings, wherein the distal end prevents the body from being slidably removed over the distal end. The middle potion includes a breakaway segment positioned within the cavity. The breakaway segment has a tensile strength less than that of the proximal end, distal end and fishing line such that added tension will cause the breakaway segment to selectively break prior to breaking of the proximal end, distal end or fishing line.

The present invention provides several embodiments. In one embodiment, the breakaway segment has a thickness less than the thickness of the remainder of the insert. In another embodiment, the insert is constructed of rubber. In another embodiment, the connecting means is a closed ring to which a fishing line can be tied.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 is a perspective view of one embodiment of the present invention showing fishing sinker assembly 10.

FIG. 2 is a side elevational view thereof showing elongated insert 30 removed from and alongside weighted body 20 for clarity.

FIG. 3 is a side elevational view thereof showing weighted body 20 cross-sectioned to expose cavity 21.

FIG. 4 is a top plan view of thereof.

FIG. 5 is a bottom view thereof.

FIG. 6 is a side elevational view thereof.

FIG. 7 is a side elevational view thereof showing fishing sinker assembly 10 rotated 90 degrees from the view shown in FIG. 6.

### DETAILED DESCRIPTION OF THE INVENTION

The present invention provides a new fishing sinker assembly adapted to be used on a fishing line which will enable the fishing line to be freed if the sinker becomes caught with a minimum loss of tackle and with minimum effort.

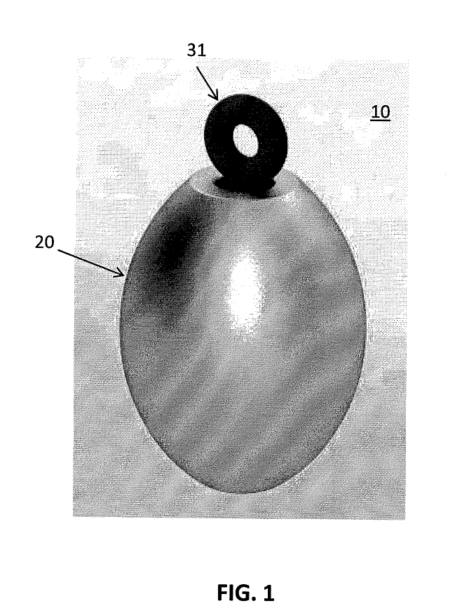

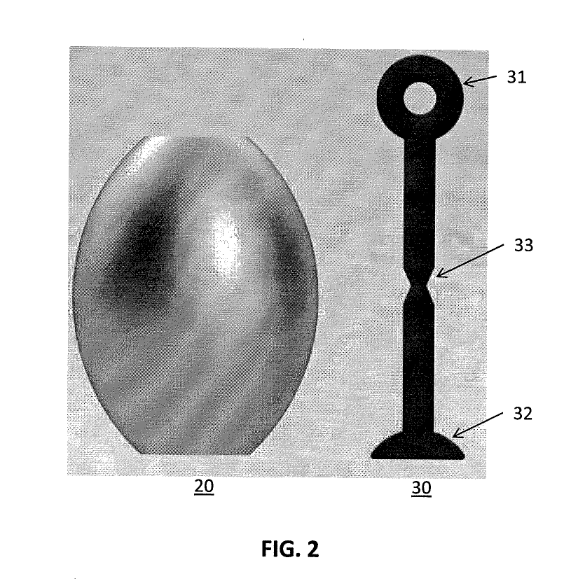

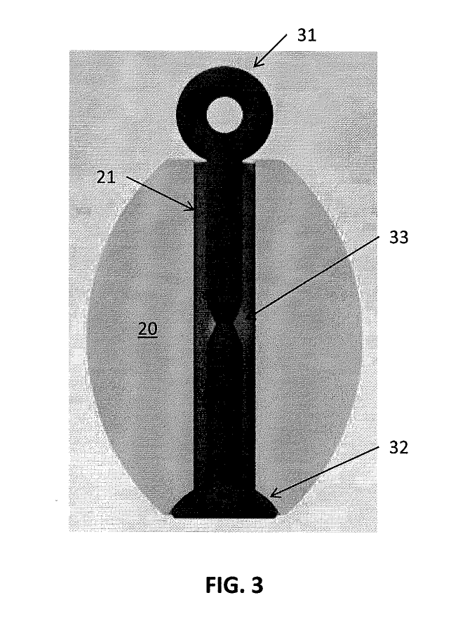

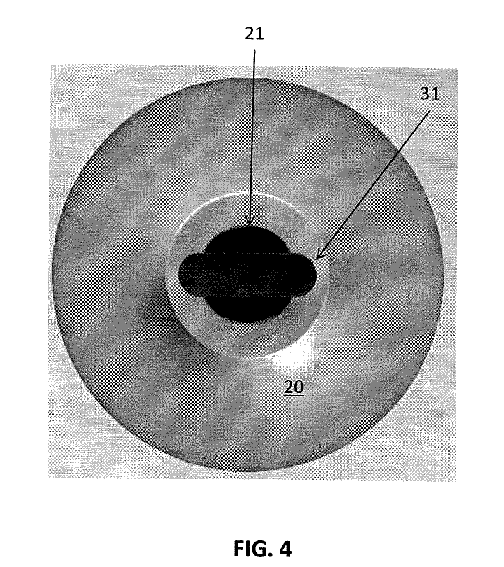

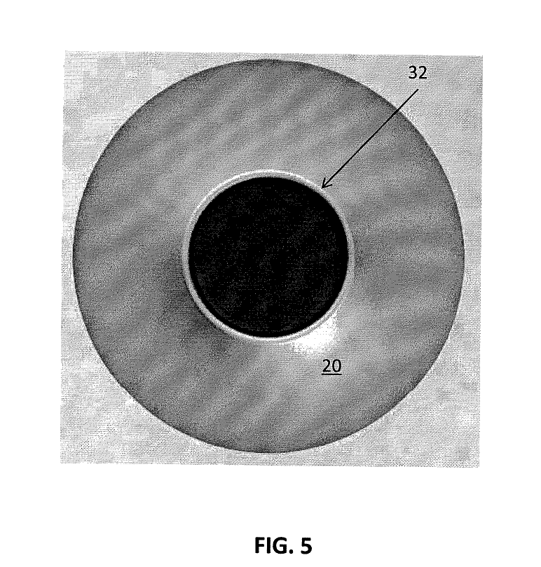

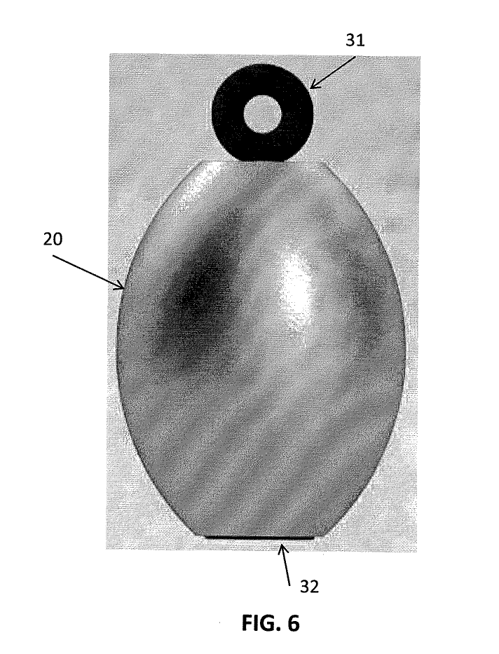

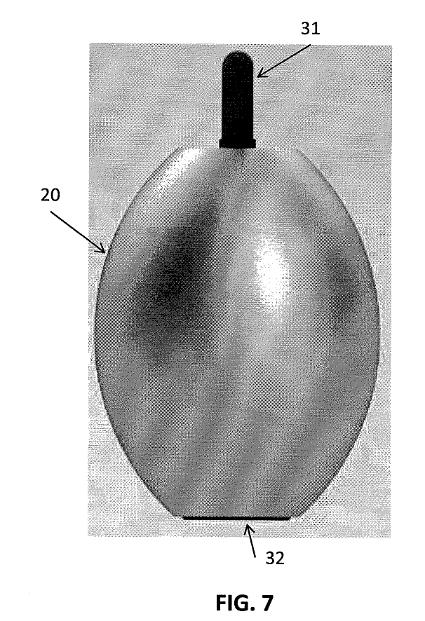

Referring generally to FIGS. 1-7, the present invention depicted as fishing sinker assembly 10 includes a weighted body 20 and an elongated insert 30. Weighted body 20 includes a throughbore defining a cavity 21 extending between two openings. Elongated insert 30 extends through cavity 21. Elongated insert 30 includes a proximal end, a distal end 32, and a middle portion. The proximal end includes a connecting means for connecting the fishing sinker to a fishing line. Distal end 32 is larger than the size of at least one of the openings, wherein distal end 32 prevents weighted body 20 from being slidably removed over distal end 32. The middle portion includes a breakaway segment 33 positioned within cavity 21, wherein breakaway segment 33 has a tensile strength less than that that of the proximal end, distal end 32 and a fishing line attached to the proximal end such that added tension will cause breakaway segment 33 to selectively break prior breaking of the proximal end, distal end 32 or the fishing line.

In one embodiment, breakaway segment 33 is a weakened portion of elongated insert 30 having a tensile strength less than that of the remainder of elongated insert 30. Tensile strength may be reduced by decreasing the diameter of breakaway 33 segment compared to the remainder of elongated insert 30. The decreased thickness of breakaway segment 33 allows for selective breaking of the segment under less tension than that required to break the remainder of elongated insert 30 or a fishing line attached thereto. Accordingly, breakaway segment 33 breaks when snagged on kelp, rocks and the like, which prevents breaking the fishing line, swivels or loss of hooks or lures. For example, an elongated insert designed for use with an 8 lb fishing line may have a breakaway segment with a tensile strength less than 8 lb, such as 4 lb or less. Nevertheless, breakaway segment 33 must have a tensile strength sufficient to withstand the force from a typical cast.

Elongated inserts 30 with breakaway segments 33 of different tensile strengths may be provided to be used in conjunction with fishing lines of different tensile strengths. In such cases, the tensile strength of the breakaway segment 33 is calibrated to be less than that of its corresponding fishing line such that the breakaway segment 33 will selectively break under added tension prior to breaking of the fishing line.

Locating breakaway segment 33 within cavity 21 protects breakaway segment 33 from breaking when the sinker assembly is not snagged. For example, underwater objects may come into direct contact with an exposed breakaway segment, causing it to break even though the sinker assembly is not snagged. Additionally, locating breakaway segment 33 within cavity 21 makes the releasable fishing sinker assembly more streamlined, thus avoiding entanglement with underwater obstructions and minimizing the possibility of snagging.

Elongated insert 30 is may be constructed of rubber. Preferably, at least breakaway segment 33 is constructed of rubber but may be constructed of other material with properties allowing for selective breaking under tension.

In some embodiments, the proximal end connecting means is a closed ring 31 to which a fishing line can be tied.

Having described the invention in detail, it will be apparent that modifications, variations, and equivalent embodiments are possible without departing the scope of the invention defined in the appended claims.

What is claimed is:

1. A fishing sinker assembly comprising:
a) a weighted body comprising a throughbore defining a cavity extending between two openings; and
b) an elongated insert extending through the cavity, the insert comprising:
i) a proximal end comprising a connecting means for connecting the fishing sinker to a fishing line,
a distal end larger than the size of at least one of the openings, wherein the distal end prevents the body from being slidably removed over the distal end, and
iii) a middle portion comprising a breakaway segment positioned within the cavity, wherein the breakaway segment comprises a tensile strength less than that of the proximal end, distal end and fishing line such that added tension will cause the breakaway segment to selectively break prior to breaking of the proximal end, distal end or fishing line.

2. The fishing sinker assembly of claim 1, further wherein the breakaway segment comprises a thickness less than the thickness of the remainder of the insert.

3. The fishing sinker assembly of claim 1, further wherein the insert is constructed of rubber.

4. The fishing sinker assembly of claim 1, further wherein the connecting means comprises a closed ring to which a fishing line can be tied.
